(19) United States
(12) Patent Application Publication
(10) Pub. No.: US 2026/0023806 A1
(43) Pub. Date: Jan. 22, 2026

(54) CONTENT BLOCKER DETECTION AND CONTENT OBFUSCATION SYSTEM

(71) Applicant: AIDEM US, Inc., New York, NY (US)

(72) Inventor: Giovanni Sollazzo, New York, NY (US)

(21) Appl. No.: 19/275,822

(22) Filed: Jul. 21, 2025

Related U.S. Application Data
(60) Provisional application No. 63/673,445, filed on Jul. 19, 2024.

(51) Int. Cl. G06F 16/958

(52) U.S. Cl. CPC G06F 16/958

(57) ABSTRACT

Systems, tools and methods for obfuscating content requested by users. The system receives requests for content from a browser running on a client device. The system may be configured to determine if content blocking software and/or functionality is running/enabled on the user's browser. When content blocking has been detected, the system may execute one or more obfuscation processes on the requested content. The obfuscation processes may be configured to replace, modify and/or encrypt one or more content elements, including advertisements, within the requested content. The obfuscated content may then be sent to the client device to be rendered in the browser. The obfuscating of the content allows the advertisements to be rendered/displayed to the user in the browser without triggering the content blocker.

### CROSS-REFERENCE TO RELATED APPLICATIONS

This application claims the benefit of priority to U.S. Provisional Application No. 63/673,445, filed on Jul. 19, 2024, which is hereby incorporated by reference in its entirety.

### FIELD

The present invention relates generally to systems, tools and methods to obfuscate web based content from content blockers.

### BACKGROUND

The use of popup blockers, ad blockers and blockers of other forms of content limit the reach of publishers and other content providers. The blockers may cause a reduction in revenue for a content provider and negatively impact user experience. The current invention rectified this problem by providing a framework that allows for circumventing the blockers.

### SUMMARY

The platform, systems and methods described herein provide for detection of content blockers and obfuscation of content being delivered to a user. The platform may comprise an obfuscation server, wherein the obfuscation server may further comprise a memory, one or more processors, one or more network devices, and one or more datastores.

In some embodiments, the obfuscation server may be configured to detect a content blocker operating on a browser. The detection may comprise receiving, from the browser, a first request for a webpage. Based on the first request, a unique ID for the browser may be determined. A blocker status record for the unique ID may then be generated in the datastore. The blocker status record may comprise a content blocker state. The detection may further comprise retrieving, from a webserver, an original webpage corresponding to the first request. A modified webpage may then be generated by appending a canary path to the original webpage. The modified webpage may then be returned to the browser. The detection may further comprise receiving, a next request from the browser and determining, for the next request, a request type. Based on the request type, the content blocker state for the browser may be determined.

In some embodiments, the request type of the next request may be a canary path request and the content blocker state may be determined to be false based on the next request being a canary path request.

In some embodiments, the request type of the next request may not be a canary path request and the content blocker state may be determined to be true based on the next request not being a canary path request.

In some embodiments, the obfuscation server may be further configured to receive, from the browser, a current request and retrieve, from the datastore, a current blocker status record for the browser. Retrieving may comprise using the unique ID of the browser to query the datastore. Based on the current request, a current request type and the blocker content state of the current blocker status record, an obfuscated webpage may be generated. In some embodiments, the generating may comprise performing one or more obfuscation processes. The obfuscated webpage may then be returned to the browser.

In some embodiments, the one or more obfuscation processes may comprise replacing one or more content elements with server side rendered elements or modifying the one or more content elements by encrypting the elements or a path of the element.

In some embodiments, determining the current request type may further comprise a content evasion instruction (CEI) determination. The CEI determination may comprise checking if a request path of the current request is a valid hexadecimal string, decoding an encrypted payload, and matching the decoded payload with JSON representation of a CEI instruction set.

In some embodiments, the unique ID of the browser may be based on JA3 and/or JA4 fingerprinting of a TLS handshake.

In some embodiments, the content obfuscation system may comprise an obfuscation server. In some embodiments, the obfuscation server may comprise one or more processors, a memory and a datastore. The datastore may comprise one or more blocker status records, wherein each blocker status record may further comprise a content blocker state. Each blocker status record may correspond to a unique ID of a browser.

In some embodiments, the obfuscation server may further comprise a content obfuscator module. The content obfuscator module may be configured to update, in the datastore, the one or more blocker status records based on one or more received requests. The updating may comprise identifying, for each of the one or more received requests, a current unique ID and determining, for each of the one or more requests, a current request type. A current blocker state in a current blocker status record corresponding to the current unique ID may be set for each of the one or more requests based on the determined current request type and a previous blocker state of the current blocker status record. In some embodiments, a fetch handling module may be configured to receive a first request for a first webpage from a browser operating on a client device. A first original webpage corresponding to the first request for the first webpage may then be retrieved from a webserver. Based on the received first request, a first unique ID may be determined. A blocker status record for the first unique ID may be generated in the datastore.

In some embodiments, the first original webpage may then be modified by appending a canary object and returned to the browser. In some embodiments, the fetch handling module may further be configured to receive a second request, wherein the second request may be a request for a webpage. A second original webpage corresponding to the second request may then be retrieved from the webserver. A first content blocker state of the blocker status record corresponding to the first unique ID may be retrieved from the datastore. A modified second original webpage may be generated based on the first content blocker state. The generating may comprise performing one or more obfuscation processes. The modified second original webpage may then be returned to the browser.

The appended claims may also serve as a summary of this application.

The features and components of these embodiments will be described in further detail in the description which follows. Additional features and advantages will also be set forth in the description which follows, and in part will be implicit from the description, or may be learned by the practice of the embodiments. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1 is a diagram illustrating a content obfuscation environment in which some embodiments may operate.

FIG. 2A is a diagram illustrating a client device in accordance with aspects of the present disclosure.

FIG. 2B is a diagram illustrating an exemplary content server in accordance with aspects of the present disclosure.

FIG. 3A is a flow chart illustrating an exemplary method that may be performed in accordance with some embodiments.

FIG. 3B is a flow chart illustrating an exemplary method that may be performed in accordance with some embodiments.

FIG. 3C is a flow chart illustrating an exemplary method that may be performed in accordance with some embodiments.

FIG. 4 is a diagram illustrating an exemplary computer/control system that may perform processing in some embodiments and in accordance with aspects of the present disclosure.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

The following generally relates to a system, platform and methods for content blocker detection and circumvention.

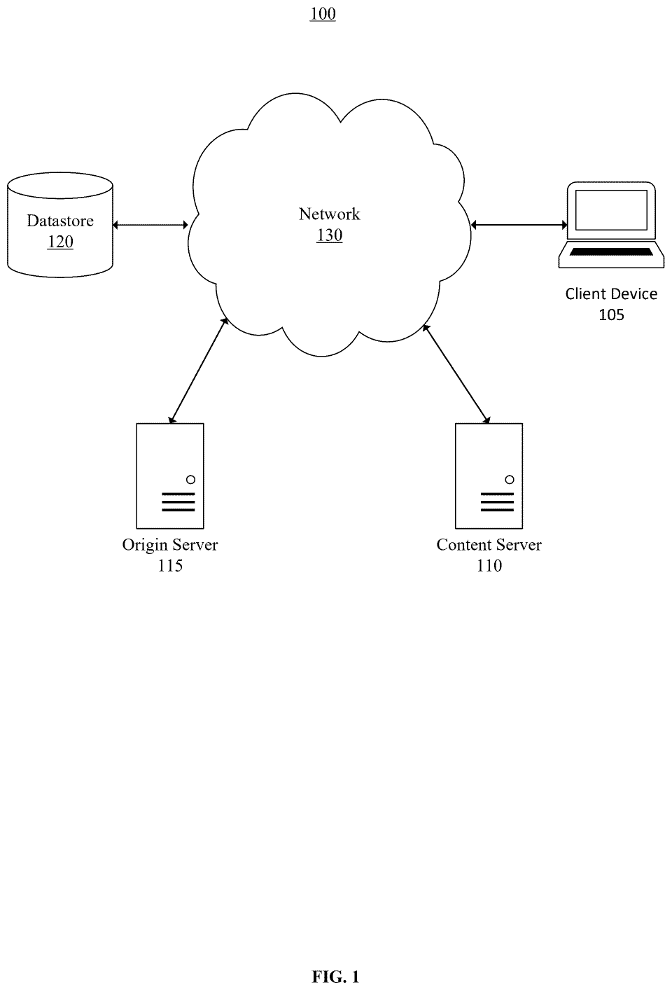

FIG. 1 is a diagram illustrating an exemplary content obfuscation environment 100 in which some embodiments may operate. The content obfuscation environment 100 may comprise one or more client devices 105, one or more content servers 110, one or more origin servers 115, one or more datastores 120 and one or more networks 130.

The one or more client devices 105 may be any computing device in which one or more web browsers may operate. In some embodiments, the client device may further be configured to execute one or more applications, wherein the one or more applications may display content served over network 130. In some embodiments, the one or more web browsers and/or the one or more applications may be configured to render content received from content server 110 and/or origin server 115. The content to be rendered may include one or more advertisements. The one or more client devices may be in communication with the one or more content servers 110, one or more origin servers 115 and one or more datastores 120 through network 130.

The content servers 110 may be one or more physical or virtual machines configured to communicate with the one or more client devices 105, one or more origin servers 115 and the one or more datastores 120. The one or more content servers 110 may be configured as a distributed computing infrastructure. In some embodiments, the content servers 110 may be implemented as one or more cloud services.

In some embodiments, the content servers 110 may be configured to detect content blocking software operating on the one or more client devices 105. When content blocking software is detected by the content server 110, one or more obfuscation processes may be performed on content, including one or more advertisements, requested from origin servers 115.

The origin servers 115 may be one or more physical or virtual machines configured to communicate with the one or more client devices 105, one or more content servers 110 and one or more datastores 120. The one or more origin servers 115 may be configured as a distributed computing infrastructure. The origin servers 115 may be the same or separate devices from that of content server 110. Origin servers 115 may be configured to deliver content to client devices 105 either directly or indirectly through content server 110.

In some embodiments, the content being served by origin server 115 may include one or more advertisements and/or placeholders for advertisements. The advertisements and/or placeholders for advertisements may be sent, along with the corresponding content, to the one or more client devices 105. When no content blocker is detected by the content server 110, the content may be directly sent from the origin server 115 to the client device. In some embodiments, when no content blocker is detected by the content server 110, the requested content may be relayed from the origin servers 115 to the client device 105 through the content server 110 without being obfuscated.

Datastores 120 may communicate with one another over network 130. Datastores 120 may be any storage device capable of storing data for processing or as a result of processing information at the client devices 105, content servers 110 and/or origin servers 115. The datastores 120 may be a separate device or the same device as content server 110 or origin server 115. The datastores 120 may be located in the same location as that of content servers 110 and/or origin servers 115, or at separate locations.

Network 130 may be an intranet, internet, mesh, LTE, GSM, peer-to-peer or other communication network that allows the one or more content servers 110 and one or more origin servers 115 to communicate with the one or more client devices 105 and datastores 120.

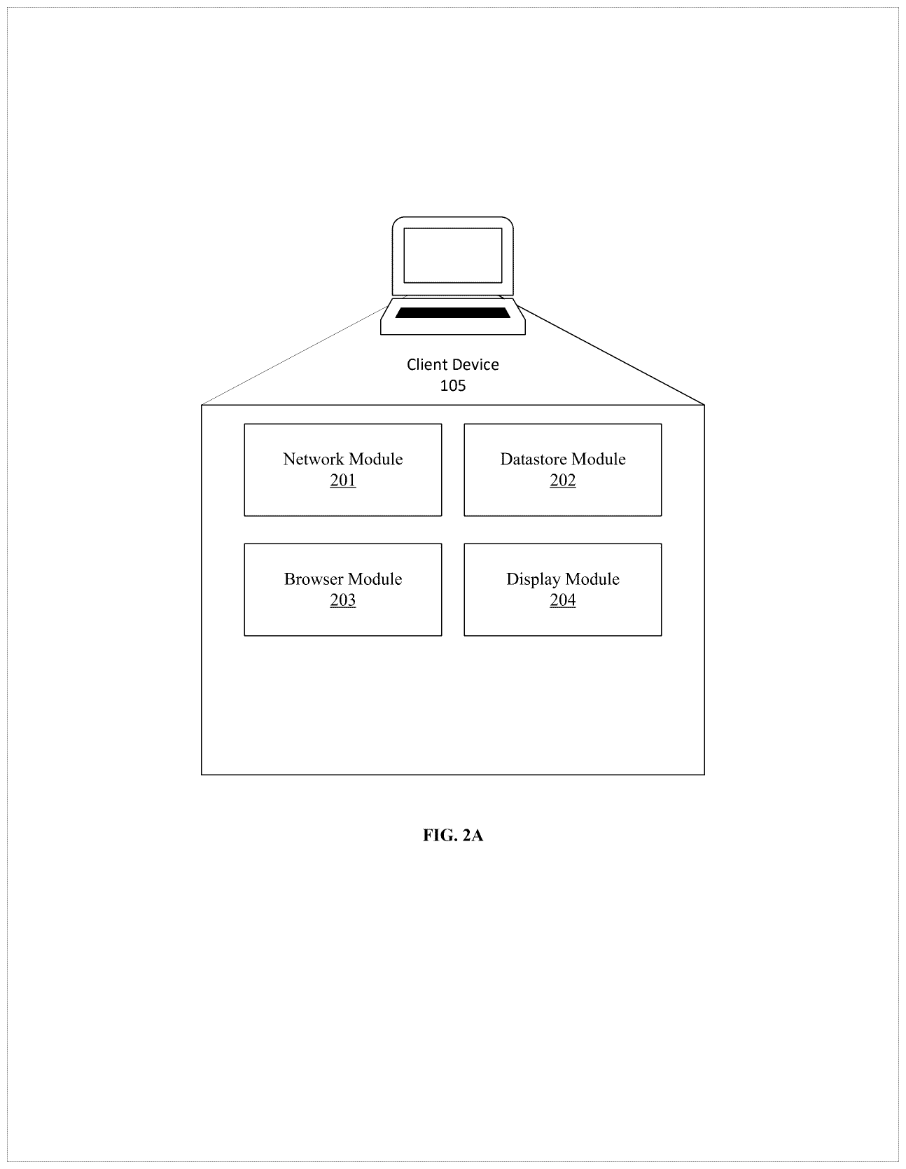

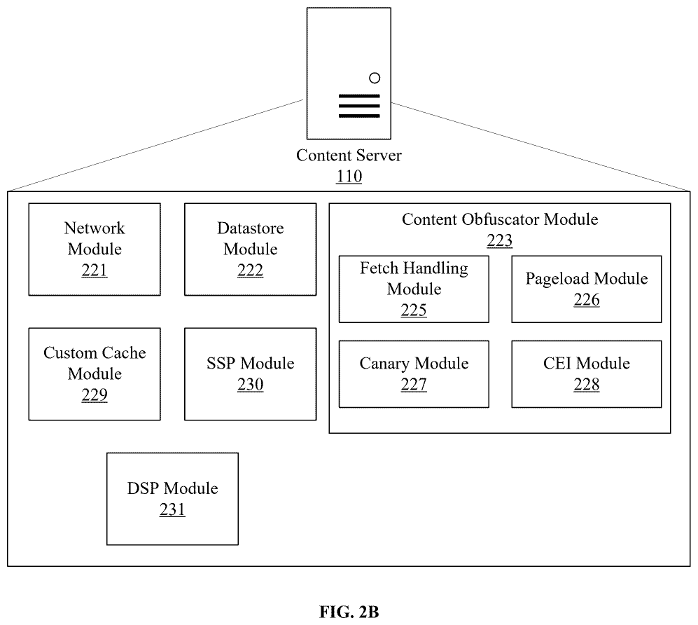

FIG. 2A is a diagram illustrating an exemplary client device 105 in accordance with aspects of the present disclosure. Client device 105 may comprise network module 201, datastore module 202, browser module 203 and display module 204.

Network module 201 may transmit and receive data from other computing systems via a network such as network 130 as described above with regard to FIG. 1. In some embodiments, the network module 201 may enable transmitting and receiving data from the Internet. Data received by the network module 201 may be used by the other modules. The modules may transmit data through the network module 201.

The datastore module 202 may be configured to store information generated by the one or more modules operating on the client device 105. The one or more modules operating on client device may also retrieve information from the datastore module 202. Datastore module 202 may also be configured to receive and store information received over network module 201.

Browser module 203 may be configured to send requests for content, receive the requested content and render the received content for display on display module 204.

Display module 204 may be any device capable of visually displaying the rendered content received from the browser module 203. In some embodiments, the display module 204 may be an LCD display, DLP display, OLED display, TFT display or any other display device.

FIG. 2B is a diagram illustrating an exemplary content server 110 in accordance with aspects of the present disclosure. Content server 110 may comprise network module 221, datastore module 222, content obfuscator module 223, custom cache module 229, SSP module 230 and DSP module 231.

Network module 221 and datastore module 222 may be the same or similar to that of network module 201 and datastore module 202 as described above with regard to FIG. 2A. Datastore module 222 may also be the same or similar to custom cache module 229 as described below.

Content obfuscator module 223 may further comprise fetch handling module 225, pageload module 226, canary module 227 and CEI module 228. In some embodiments, the content obfuscator 223 may be configured to modify one or more element paths in a requested webpage. In some embodiments, only paths corresponding to advertisements may be modified in order to circumvent a detected content blocker. The modification of advertisement paths may include reducing the length of the path when the hex string is larger than a predetermined threshold value. In some embodiments, all paths of a requested webpage may be modified. The modification may include changing every URL in the original HTML webpage to a LoadURL content evasion instruction (CEI).

Fetch handling module 225 may be configured to handle HTTP fetch requests from a client browser. The handling may comprise assessing the nature of the request (request type). A logic sequence, classification process or other assessment process may be used to determine the request type. A request type may correspond to one of a plurality of categories. Based on the assessment of the request type, additional logic sequences or processes may be triggered. In some embodiments, the additional logic sequences/processes may comprise execution of one or more instructions of an instruction set. In some embodiments, there may be a separate process flows for each of the plurality of request type categories. In some embodiments, there may be process flows corresponding to a canary path request type, a static resource request type, a CEI request type or a pageload request type.

Pageload module 226 may be configured to process pageload events. In some embodiments, the pageload module 226 may be configured to receive a pageload request from the fetch handling module 225. The pageload module 226 may further retrieve, from a webserver, a webpage or content corresponding to the pageload request. The pageload module 226 may further be configured to receive a pageload event corresponding to the pageload request. A status check may then be performed (status 200) to ensure that only successful pageloads proceed. The pageload module 226 may further be configured to perform a Content-Type verification process. The Content-Type verification process may comprise checking a Content-Type header to ensure that it is HTML. In some embodiments, the Content-Type verification may be performed by the fetch handling module 225 during the classification/determination of the request type. The pageload module 226 may further be configured to check the datastore for an entry corresponding to a unique ID of the browser associated with the received request. If no entry exists, an entry may be added to the datastore for the unique ID and the entry may be set to a value of UNKNOWN, or any other value indicating that a content blocker state is unknown.

If an entry exists, and the blocker status of the entry is true, this indicates that the browser has a content blocker enabled and the requested webpage/content needs to have one or more obfuscation processes performed on some or all of the webpage/content. In some embodiments, one or more elements of the webpage/content may be replaced with a server-side rendering of the element. In some embodiments, one or more elements of the webpage or content may be encrypted before being returned to the browser. In some embodiments, all elements may be encrypted. After performing the one or more obfuscation processes on the webpage/content, the resulting obfuscated webpage/content may be returned to the browser with a canary path appended to the end.

If an entry exists, and the blocker status of the entry is false, this indicates that the browser does not have a content blocker enables. The original webpage/content corresponding to the request may be returned with a canary appended to the end.

If an entry exists, and the blocker status of the entry is UNKNOWN, this indicates that the use of a content blocker by the browser is unclear. The entry may be updated with a value of true, out of an abundance of caution to potentially identify blocker usage. The request may then be processed in the same manner as described above with regards to an entry set to true.

Canary module 227 may comprise a canary event logic sequence. The canary event logic sequence may be an essential part of the content blocker detection system, updating and confirming the status of content blocker use by checking the accessibility of a known content blocked path (canary path). The canary module 227 may be configured to return an HTTP response status code 204 (No Content) along with a cache-header set to ‘no-store’ to ensures that the browser always checks the status of the Canary and thereby providing up-to-date information about content blocker usage for each unique user.

In some embodiments, the canary path may be static or dynamic. The canary module may be configured to scrape or retrieve one or more lists of regexes from one or more public repositories of content blockers. The canary module 227 may generate/build the canary path based on the scraped/retrieved lists, wherein the generated canary path is designed to trigger said regexes and therefore always be detected by an enabled content blocker of a browser.

CEI module 228 may be configured to handle CEI instruction sets, ensuring secure and effective processing of scripting instructions. The CEI instruction sets may comprise one or more instructions to be executed. In some embodiments, the CEI module 228 may be configured to perform a CEI instruction set verification process. The CEI instruction set verification process may comprise a hex string validation, decoding and payload verification. The hex string validation may be configured to check if the request path is a valid hexadecimal string. A validated hex string may then be decoded and the decoded payload may be compared against a representation of a CEI instruction set. In some embodiments, the decoding may be an AES-GCM decoding process. In some embodiments, the decoded payload may be compared against a JSON representation of a CEI instruction set. In some embodiments, the decoded payload may be returned as bytes and assessed against the structure of a CEI instruction set interface to confirm its authenticity as a valid CEI instruction set. In some embodiments, the CEI instruction set verification may be performed by the fetch handling module 225 during the classification/determination of the request type.

In some embodiments, after the verification that the decoded payload is a CEI instruction set, each instruction contained in the CEI instruction set may be processed by the CEI module 228.

In some embodiments, the CEI instruction set may comprise one or more LoadURL instructions, one or more LoadBase64 instructions, one or more redirect instructions and/or instructions for streaming, decoding, encoding, and/or returning content to the browser.

In some embodiments, the LoadURL process may be configured to verify the TTL of the CEI instruction set. If valid, the response may be returned as a stream. In cases where the instruction includes win notice data, a network request to the SSP and/or DSP win notice endpoint may be initiated.

In some embodiments, the LoadBase64 process may be configured to verify the TTL is valid. If so, the decoded base64 may be returned as a byteStream. For win notice data, a network request to the SSP and/or DSP win notice endpoint may be initiated.

In some embodiments, the Redirect process may be configured to confirm the TTL's validity. If valid, a response that triggers a redirection to the specified URL may be returned. For win notice data, a network request to the SSP and/or DSP win notice endpoint may be initiated.

Custom cache module 229 may be configured to store one or more blocker status records. Each of the one or more blocker status records may comprise a content blocker status and a unique identifier corresponding to a specific browser operating on a client device. In some embodiments, the unique identifier may be generated based on a user agent (UA) string, IP address, MAC address and/or SSL/TLS handshake fingerprinting. The SSL/TLS handshake fingerprinting may use a JA3 or JA4 method for creating the fingerprint. In some embodiments, the unique identifier may also use a JA4 fingerprinting method corresponding to one or more additional network protocols. In some embodiments, the blocker status records may further comprise a timestamp recording the last time the record was accessed/updated. In some embodiments, the custom cache may be configured to remove any blocker status record with a timestamp older than a predetermined threshold time.

In some embodiments, the custom cache module 229 of each of the one or more content servers 110 may be configured to be isolated from one another. The custom cache modules 229 therefore may be restricted from sharing content of the module with other servers, keeping the collected data secure and ensuring that the data is not retained after a predetermined period after the last timestamp associated with the data.

In some embodiments, the custom cache module 229 may be configured to sync or share the data stored with one or more collocated content servers 110, while restricting transmission or sharing of that data with content servers at a different physical location. Content servers 110 may be considered to be collocated if they are within the same building, complex, campus, city, state, province, country, or other delineated boundary. For example, the custom cache module 229 may be configured only to share/sync with content servers located within the same country, such as the United States or the United Kingdom. In some embodiments, a content server 110 located in a European Union member state may be restricted to sharing/synchronizing the custom cache module 229 data with other content servers within the European Union.

In some embodiments, the custom cache module 229 may be configured to select a set of content servers 110 (i.e., zero to all content servers) to share/sync data with. The selection may be based on local, regional, national or international regulations regarding transfer of customer data.

SSP module 230 may be configured to allow a content publisher or owner, including web publishers and media owners, the ability to manage their advertising inventory, fill it with ads, and receive revenue. The SSP module may further be configured to automate and optimize the selling of their content.

DSP module 231 may be a platform for advertisers to automate the process of buying and selling advertising impressions.

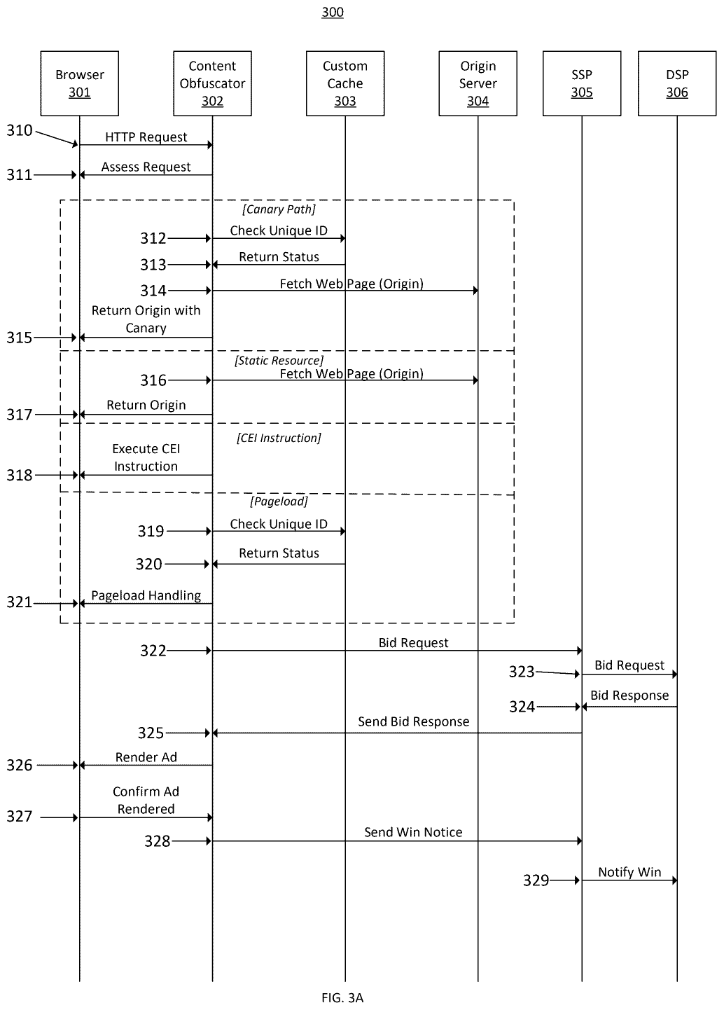

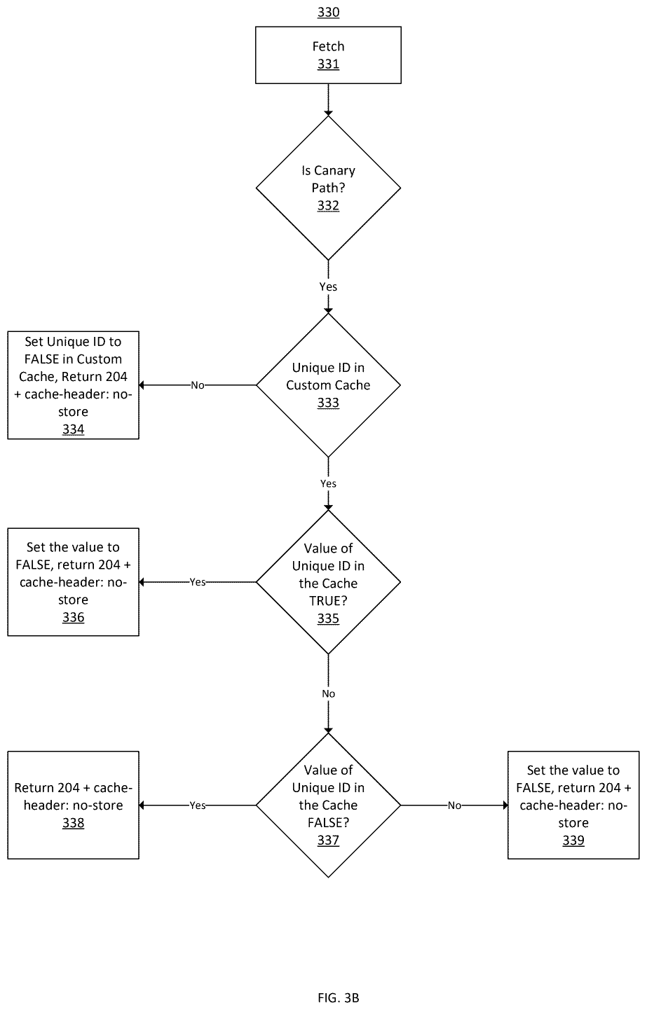

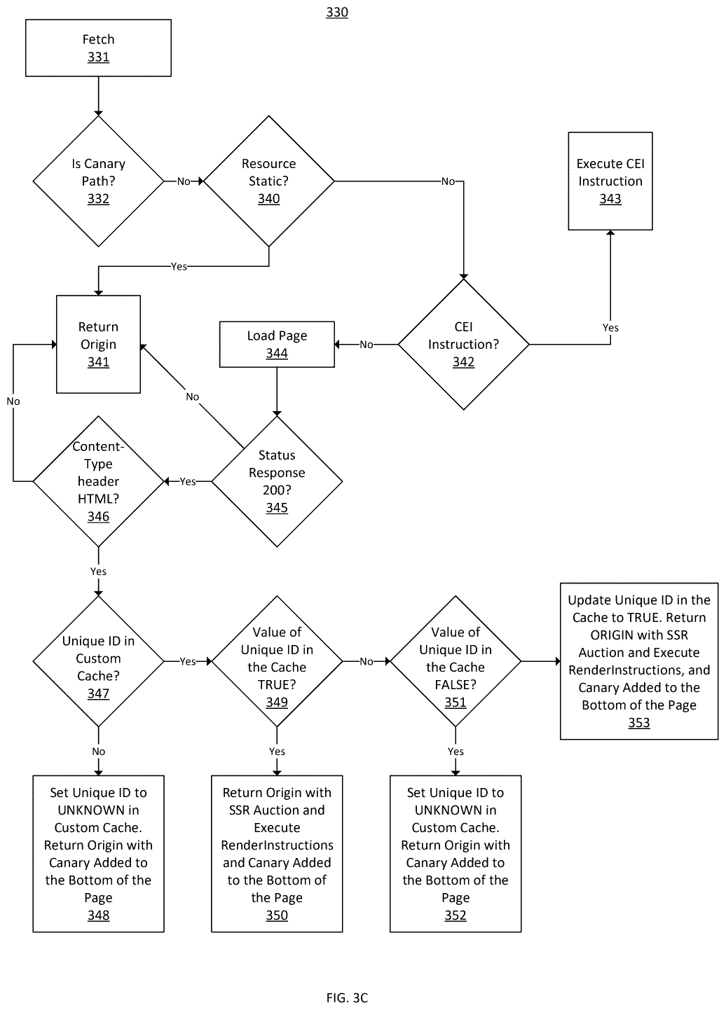

FIG. 3A is a flow chart illustrating an exemplary method 300 that may be performed in accordance with some embodiments. The method 300 may comprise interactions/communication between one or more modules. The one or more modules include browser 301, content obfuscator 302, custom cache 303, origin server 304, SSP 305 and DSP 306. In some embodiments, one or more of the one or more modules may be run/operate on the same server/system. In some embodiments, one or more of the one or more modules may correspond to modules running on separate servers/system.

At step 310, a browser may send an HTTP request for a webpage to the content obfuscator 302.

At step 311, the content obfuscator 302 is configured to assess the request from the browser and determine if the request corresponds to a canary path, a static resource or content evasion instructions (CEI). If a canary path is detected, the content obfuscator 302 may proceed with steps 312-315. If a static resource is requested, the content obfuscator 302 may proceed to step 316. If a CEI request is detected, the content obfuscator 302 may proceed to step 317.

At step 312, the content obfuscator 302 may be configured to extract information from the received request, generate or identify a unique ID corresponding to the web browser making the request and use unique ID to query the custom cache 303.

At step 313, the custom cache may return the content blocker status of the browser to the content obfuscator 302. In some embodiments, the content blocker status may be set to TRUE, FALSE, or UNKNOWN.

At step 314, the content obfuscator 302 may be configured to fetch the requested webpage (Origin webpage) from the Origin server (webserver) 304.

At step 315, the content obfuscator 302 may modify the Origin webpage by appending a canary object to the end of the page. In some embodiments, the canary object may be placed at other positions within the webpage.

At step 316, when the content obfuscator 302 has determined that the request is for a static resource, the content obfuscator may be configured to fetch the requested Origin webpage from the Origin server 304.

At step 317, the content obfuscator 302 may be configured to return the Origin webpage in response to the static resource request.

At step 318, the content obfuscator 302 may be configured to execute one or more CEIs and return the response of the execution to the browser. In some embodiments, the response may be returned to the browser as a stream, a trigger such as a redirect or other instruction. In some embodiments, the one or more CEIs may be executed by the browser. In some embodiments, the one or more CEIs may be executed on both the content obfuscator 302 and browser.

At step 319, the content obfuscator 302 may receive a pageload event and check the unique ID of the browser against the custom cache 303.

At step 319, the custom cache 303 may return the content blocker status to the content obfuscator 302.

At step 320, a pageload handling process may be initiated. The page load handling process may include a pageload event logic sequence. In some embodiments, the pageload event logic sequence may comprise receiving a pageload event, a status check, a content-type verification, and a custom cache check.

In some embodiments, the pageload event logic sequence may start with the recognizing that a pageload event has occurred. The status check may be configured to determine a status code corresponding to a response to the server. If the response status is not 200 (i.e., successful response), the Origin webpage may be returned to the browser. This ensures only successful pageloads proceed.

The content-type verification may be used to ensure that the content-type header is HTML. If not (indicating a non-HTML or static asset), the Origin webpage may be returned to the browser.

The custom cache check may determine if there is an existing entry for the unique ID and IP address combination in the custom cache 303. If there is no existing entry, an entry with Unique ID=UNKNOWN may be added to the custom cache 303 and the Origin webpage, with the Canary appended to the bottom of the page, may be returned to the browser. This may be used as the initial step for new users or the first identification of a browser's unique ID.

If an entry exists, the entry may comprise a content blocker status for the entry. In some embodiments, the content blocker status of an entry may be set to one of three values (TRUE, FALSE and UNKNOWN). A value of TRUE may correspond to the user using a browser with an enabled content blocker. A value of FALSE may correspond to the user using a browser without a content blocker or a content blocker that is disables. A value of UNKNOWN may correspond to the content blocker status of the user/browser being unclear.

When the content blocker status of the browser is determined to be TRUE, the content obfuscator 302 may return the Origin webpage with the Server-Side Rendered (SSR) Auction and the Canary appended to the bottom of the page, as well as execute any RenderInstructions.

When the content blocker status of the browser is determined to be FALSE, the content obfuscator 302 may return the Origin webpage with the Canary appended to the bottom of the page. This continues normal user experience without content blocker intervention.

When the content blocker status of the browser is UNKOWN, the content obfuscator 302 may update the content blocker status of the entry corresponding to the Unique ID of the browser with a value of TRUE, return the Origin webpage with SSR Auction and the Canary appended to the bottom of the page, and also execute RenderInstructions. This action is taken as a cautious approach to potentially identify content blocker usage.

This sequence allows for the efficient handling of pageload events with a focus on detecting content blocker usage while maintaining user experience and system performance. The integration of custom cache 303 may be used to allow for a swift and effective response based on the history and behavior of the user, optimizing both ad delivery and content integrity.

At steps 321-328, the system may be configured to facilitate the auctioning of advertisements through real time bidding (RTB). In some embodiments, the content obfuscator 302 may be a comprehensive RTB platform that integrates both the demand-side platform (DSP 306) and the supply-side platform (SSP 305), acting as a centralized hub. The RTB platform may comprise tools for both direct and programmatic sales management, as well as controls for targeting, optimization, and performance analytics.

FIG. 3B is a flow chart illustrating an exemplary method 330 that may be performed in accordance with some embodiments.

At step 331, a fetch request is received and processed by the content obfuscator. The fetch request, information corresponding to the fetch request, and information received as a result of processing the fetch request may be used as the basis for decisions in one or more logic sequences.

At step 332, a fetch handling logic sequence is initiated and a determination as to whether or not the request corresponds to a canary path is made. If the request does correspond to a canary path, the fetch handling logic sequence proceeds to step 333. However, if the request does not correspond to a canary path, the fetch handling logic sequence proceeds to step 340 of FIG. 3C.

At step 333, a canary event logic sequence is initiated in the content obfuscator 302. The canary event logic sequence may be configured to check the custom cache 303 for an entry corresponding to the browser associated with the request. The checking may be performed by querying the custom cache 303, wherein the query comprises the Unique ID and IP address of the browser. The canary event logic sequence may then proceed to step 334 when no entry is found in the custom cache 303 or to step 335 when an entry is identified.

At step 334, when the entry is not found, the content obfuscator may add a new entry to the custom cache 303 for the browser. The new entry may comprise a key/index value based on the Unique ID and the IP address of the browser and a content blocker status. In some embodiments, other key/index values may be used to uniquely identify cache entries and browsers. When adding the new entry to the custom cache, the content obfuscator may set the initial content blocker status value to FALSE. The system may be configured to assume that no content blocker is detected initially. The canary event logic sequence may then be configured to return an HTTP response status code 204 (No Content) along with a cache-header set to ‘no-store’ to ensure the browser always makes a call to the Canary endpoint/path for every session or page reload.

At step 335, the canary event logic sequence checks the value of the content blocker status for the entry found in step 333. The canary event logic sequence may then proceed to step 336 when the content blocker status value of the cache entry is TRUE, indicating previous detection of a content blocker. If the content blocker status value is not TRUE, the canary event logic sequence may proceed to step 337.

At step 336, the content obfuscator may update, for the entry Unique ID in the custom cache 303, the content blocker status value to FALSE, as the Canary has been successfully loaded, and return an HTTP response status code 204 (No Content) along with a cache-header set to ‘no-store’. This may indicate the user has disabled the content blocker or the content blocker does not block the Canary.

At step 337, the canary event logic sequence checks the value of the content blocker status for the entry found in step 333. The canary event logic sequence may then proceed to step 338 when the content blocker status value of the cache entry is FALSE, indicating no previous detection of a content blocker. If the content blocker status value is not FALSE, the canary event logic sequence may proceed to step 339.

At step 338, the content obfuscator may return an HTTP response status code 204 (No Content) along with a cache-header set to ‘no-store’. No update to the content blocker status need be made as the canary continues to be unblocked.

At step 339, the content blocker status value may be UNKNOWN or any value not TRUE or FALSE, indicating an uncertain content blocker status. At this step, the content obfuscator may update, for the entry Unique ID in the custom cache 303, the content blocker status value to FALSE, as the Canary has been successfully loaded, and return an HTTP response status code 204 (No Content) along with a cache-header set to ‘no-store’.

FIG. 3C is a flow chart illustrating an exemplary method 330 that may be performed in accordance with some embodiments.

Continuing from steps 331 and 332, where the fetch handling logic sequence has determined that the request does not correspond to a canary path, the fetch handling logic sequence proceeds to step 340.

At step 340, the fetch handling logic sequence is configured to check if the request is as a static resource (such as images, videos, JavaScript, CSS, etc.). If the request is identified as a static resource request, the fetch handling logic sequence proceeds to step 341, where the Origin webpage is returned to the browser. If the request is not a static resource request, fetch handling logic sequence proceeds to step 342.

At step 342, fetch handling logic sequence is configured to check if the request contains a CEI. If the request does contain a CEI, the fetch handling logic sequence proceeds to step 343, where the CEI is executed. In some embodiments, the execution of the CEI may be performed through the implementation of a CEI logic sequence. If the request is not a CEI, the fetch handling logic sequence proceeds to step 344.

At step 344, a pageload event logic sequence initiated. The pageload event logic sequence may be configured to receive a pageload event and/or recognize that a pageload event has occurred. In some embodiments, an HTTP response status code corresponding to the pageload event may be received by the pageload event logic sequence initiated.

At step 345, the pageload event logic sequence may check the received HTTP response status code. If the HTTP response status code is not 200 (OK), the pageload event logic sequence may proceed back to step 341 and return the Origin webpage to the browser. Otherwise, proceed to step 346.

At step 346, the pageload event logic sequence may be configured to perform a content-type verification, wherein the content-type header is checked. If the content-type header is not HTML, the pageload event logic sequence proceeds back to step 341, and the Origin Webpage is returned to the browser. If the content-type header is HTML, proceed to step 347.

At step 347, the pageload event logic sequence performs a custom cache check, the custom cache check is configured to verify that there is an existing entry in the custom cache for the Unique ID corresponding to the browser associated with the request. If no entry exists, the pageload event logic sequence proceeds to step 348, and if an entry does exist the pageload event logic sequence proceeds to step 349.

At step 348, the pageload event logic sequence is configured to add an entry to the custom cache with Unique ID=UNKNOWN and return Origin webpage with the Canary appended to the bottom of the page when no existing entry is found. This may be used as the initial step for new users or the first identification of a browser's unique ID.

At step 349, the pageload event logic sequence checks the content blocker status value of the entry found in the custom cache. If the content blocker status is set to TRUE, the pageload event logic sequence proceeds to step 350, otherwise it proceeds to step 351.

At step 350, the pageload event logic sequence has determined that the user is using an content blocker and the content obfuscator is configured to return, to the browser, the Origin webpage with Server-Side Rendered (SSR) Auction and a canary path appended to the bottom of the page, as well as executing any RenderInstructions present.

At step 351, the pageload event logic sequence checks if the content blocker status value is set to FALSE. If the value is FALSE, the pageload event logic sequence proceeds to step 352, otherwise it proceeds to step 353.

At step 352, the pageload event logic sequence has determined that the user is not using a content blocker. The content obfuscator may then return to the browser, the Origin webpage with the Canary appended to the bottom of the page. This continues the normal user experience without content blocker intervention.

At step 353, the content blocker status value has been determined to be a value of UNKNOWN or any other value other than TRUE or FALSE. This may indicate an uncertain content blocker status. The content obfuscator may update the custom cache, setting the entry for the Unique ID to TRUE. The content obfuscator may then return the Origin webpage with SSR Auction and the appended canary at the bottom of the page, as well as execute any RenderInstructions. This action may be taken as a cautious approach to potentially identify content blocker usage.

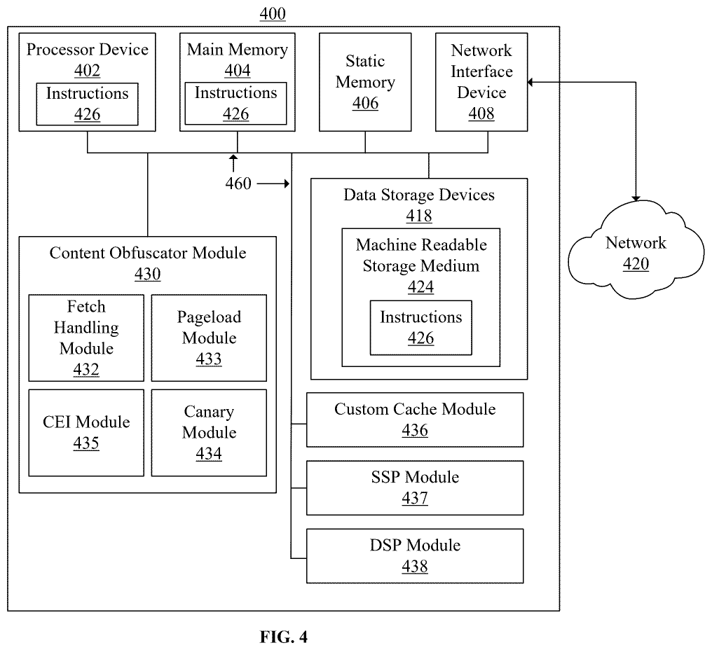

FIG. 4 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, an ad-hoc network, a mesh network, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage device 418, which communicate with each other via a bus 460.

Processing device 402 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 402 may also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein.

The computer system 400 may further include a network interface device 508 to communicate over the network 420. The computer system 400 may also include content obfuscator module 430, custom cache module 436, SSP module 437 and DSP module 438.

Content obfuscator module 430 may further comprise fetch handling module 432, pageload module 433, canary module 434 and CEI module 435.

Content obfuscator module 430, fetch handling module 432, pageload module 433, canary module 434, CEI module 435, custom cache module 436, SSP module 437 and DSP module 438 may be the same or similar to that of content obfuscator module 223, fetch handling module 225, pageload module 226, canary module 227, CEI module 228, custom cache module 229, SSP module 230 and DSP module 231 as disclosed in FIG. 2B.

The data storage device 418 may include a machine-readable storage medium 424 (also known as a computer-readable medium) on which is stored one or more sets of instructions or software 426 embodying any one or more of the methodologies or functions described herein. The instructions 426 may also reside, completely or at least partially, within the main memory 404 and/or within the processing device 402 during execution thereof by the computer system 400, the main memory 404 and the processing device 402 also constituting machine-readable storage media. Information, including data used in the processes and methods of the system and the one or more sets of instructions or software, may also be stored in blockchain, as NFTs or other decentralized technologies.

In one implementation, the instructions 426 include instructions to implement functionality corresponding to the components of a device to perform the disclosure herein. While the machine-readable storage medium 424 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

It will be appreciated that the present disclosure may include any one and up to all of the following examples.

Example 1. A content obfuscation system, wherein the system comprises: an obfuscation server, wherein the obfuscation server comprises: a memory; one or more processors; one or more network devices; and one or more datastores; and wherein the obfuscation server is configured to detect a content blocker operating on a browser, wherein the detection comprises: receiving, from the browser, a first request for a webpage; determining, based on the first request, a unique ID for the browser; generating, in the datastore, a blocker status record for the unique ID, wherein the blocker status record comprises a content blocker state; retrieving, from a webserver, an original webpage corresponding to the first request; generating a modified webpage by appending a canary path to the original webpage; returning, to the browser, the modified webpage; receiving, a next request from the browser; determining, for the next request, a request type; and determining, based on the request type, the content blocker state for the browser.

Example 2. The system of Example 1, wherein the request type of the next request is a canary path request and the content blocker state is determined to be false based on the next request being a canary path request.

Example 3. The system of any one of Examples 1-2, wherein the request type of the next request is not a canary path request and the content blocker state is determined to be true based on the next request not being a canary path request.

Example 4. The system of any one of Examples 1-3, wherein the obfuscation server is further configured to: receive, from the browser, a current request; retrieve, from the datastore, a current blocker status record for the browser, wherein the retrieving comprises using the unique ID of the browser to query the datastore; generating, based on the current request, a current request type and the blocker content state of the current blocker status record, an obfuscated webpage, wherein the generating comprises performing one or more obfuscation processes; and return, to the browser, the obfuscated webpage.

Example 5. The system of any one of Examples 1-4, wherein the one or more obfuscation processes comprise: replacing one or more content elements with server side rendered elements; or modifying the one or more content elements by encrypting the elements or a path of the element.

Example 6. The system of any one of Examples 1-5, wherein determining the current request type further comprises a content evasion instruction (CEI) determination, and wherein the CEI determination comprises: checking if a request path of the current request is a valid hexadecimal string; decoding an encrypted payload; and matching the decoded payload with JSON representation of a CEI instruction set.

Example 7. The system of any one of Examples 1-6, wherein the unique ID of the browser is based on JA3 and/or JA4 fingerprinting of a TLS handshake.

Example 8. A content obfuscation system, wherein the system comprises: an obfuscation server, wherein the obfuscation server comprises; one or more processors; a memory; a datastore, wherein the datastore comprises one or more blocker status records, wherein each blocker status record comprises a content blocker state, and wherein each blocker status record corresponds to a unique ID of a browser; a content obfuscator module, wherein the content obfuscator module is configured to: update, in the datastore, the one or more blocker status records based on one or more received requests, wherein the updating comprises: identifying, for each of the one or more received requests, a current unique ID; determining, for each of the one or more requests, a current request type; and setting, for each of the one or more requests, a current blocker state in a current blocker status record corresponding to the current unique ID based on the determined current request type and a previous blocker state of the current blocker status record; and receive, by a fetch handling module, a first request for a first webpage from a browser operating on a client device; retrieve, from a webserver, a first original webpage corresponding to the first request for the first webpage; determine, based on the received first request, a first unique ID; generate, in the datastore, a blocker status record for the first unique ID; modify, by append a canary object, the first original webpage; return, to the browser, the modified first original webpage; receive, by the fetch handling module, a second request, wherein the second request is a request for a webpage; retrieve, from the webserver, a second original webpage corresponding to the second request;

retrieve, from the datastore, a first content blocker state of the blocker status record corresponding to the first unique ID; generate, based on the first content blocker state, a modified second original webpage, wherein the generating comprises performing one or more obfuscation processes; and return, to the browser, the modified second original webpage.

Example 9. The system of Example 8, wherein the one or more obfuscation processes comprise: replacing one or more content elements with server side rendered elements; or modifying the one or more content elements by encrypting the elements or a path of the element.

Example 10. The system of any one of Examples 8-9, wherein the fetch handling module is further configured to classify each request from the browser into one or more types of requests.

Example 11. The system of any one of Examples 8-10, wherein the one or more types of requests comprise: a canary path request, wherein the canary path request corresponds to an appended canary object; a static resource request; and a content evasion instruction (CEI), wherein the CEI is encrypted;

Example 12. The method of any one of Examples 8-11, wherein the classifying comprises a CEI instruction request determination, and wherein the CEI instruction request determination comprises: checking if a request path is a valid hexadecimal string; decoding an encrypted payload; and matching the decoded payload with JSON representation of a CEI instruction set.

Example 13. The method of any one of Examples 8-12, wherein the system further comprises a canary module configured to: receive, from the fetch handling module, a first canary path request; and update a blocker status record corresponding to a unique ID associated with the first canary path request based on a current content blocker state of the blocker status record.

Example 14. The method of any one of Examples 8-13, wherein the unique ID of the browser is based on JA3 and/or JA4 fingerprinting of a TLS handshake.

Example 15. A content obfuscation method, wherein the method is configured to: detect, at an obfuscation server, a content blocker operating on a browser of a client device, wherein the detection comprises: receiving, from the browser, a first request for a webpage; determining, based on the first request, a unique ID for the browser, wherein the unique ID of the browser is based on JA3 and/or JA4 fingerprinting of a TLS handshake; generating, in the datastore, a blocker status record for the unique ID, wherein the blocker status record comprises a content blocker state; retrieving, from a webserver, an original webpage corresponding to the first request; generating a modified webpage by appending a canary path to the original webpage; returning, to the browser, the modified webpage; receiving, a next request from the browser; determining, for the next request, a request type; and determining, based on the request type, the content blocker state for the browser.

Example 16. The method of any one of Examples 12-15, wherein the request type of the next request is a canary path request and the content blocker state is determined to be false based on the next request being a canary path request.

Example 17. The method of any one of Examples 15-16, wherein the request type of the next request is not a canary path request and the content blocker state is determined to be true based on the next request not being a canary path request.

Example 18. The method of any one of Examples 15-17, wherein the obfuscation server is further configured to: receive, from the browser, a current request; retrieve, from the datastore, a current blocker status record for the browser, wherein the retrieving comprises using the unique ID of the browser to query the datastore; generating, based on the current request, a current request type and the blocker content state of the current blocker status record, an obfuscated webpage, wherein the generating comprises performing one or more obfuscation processes; and return, to the browser, the obfuscated webpage.

Example 19. The method of any one of Examples 15-18, wherein the one or more obfuscation processes comprise: replacing one or more content elements with server side rendered elements; or modifying the one or more content elements by encrypting the elements or a path of the element.

Example 20. The method of any one of Examples 15-19, wherein determining the current request type further comprises a content evasion instruction (CEI) determination, and wherein the CEI determination comprises: checking if a request path of the current request is a valid hexadecimal string; decoding an encrypted payload; and matching the decoded payload with JSON representation of a CEI instruction set.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A content obfuscation system, wherein the system comprises:
an obfuscation server, wherein the obfuscation server comprises:
a memory;
one or more processors;
one or more network devices; and
one or more datastores; and
wherein the obfuscation server is configured to detect a content blocker operating on a browser,
wherein the detection comprises:
receiving, from the browser, a first request for a webpage;
determining, based on the first request, a unique ID for the browser;
generating, in the datastore, a blocker status record for the unique ID, wherein the blocker status record comprises a content blocker state;
retrieving, from a webserver, an original webpage corresponding to the first request;
generating a modified webpage by appending a canary path to the original webpage;
returning, to the browser, the modified webpage;
receiving, a next request from the browser;
determining, for the next request, a request type; and
determining, based on the request type, the content blocker state for the browser.

2. The system of claim 1, wherein the request type of the next request is a canary path request and the content blocker state is determined to be false based on the next request being a canary path request.

3. The system of claim 1, wherein the request type of the next request is not a canary path request and the content blocker state is determined to be true based on the next request not being a canary path request.

4. The system of claim 1, wherein the obfuscation server is further configured to:
receive, from the browser, a current request;
retrieve, from the datastore, a current blocker status record for the browser, wherein the retrieving comprises using the unique ID of the browser to query the datastore;
generating, based on the current request, a current request type and the blocker content state of the current blocker status record, an obfuscated webpage, wherein the generating comprises performing one or more obfuscation processes; and
return, to the browser, the obfuscated webpage.

5. The system of claim 4, wherein the one or more obfuscation processes comprise:
replacing one or more content elements with server side rendered elements; or
modifying the one or more content elements by encrypting the elements or a path of the element.

6. The system of claim 5, wherein determining the current request type further comprises a content evasion instruction (CEI) determination, and wherein the CEI determination comprises:
checking if a request path of the current request is a valid hexadecimal string;
decoding an encrypted payload; and
matching the decoded payload with JSON representation of a CEI instruction set.

7. The system of claim 6, wherein the unique ID of the browser is based on JA3 and/or JA4 fingerprinting of a TLS handshake.

8. A content obfuscation system, wherein the system comprises:
an obfuscation server, wherein the obfuscation server comprises;
one or more processors;
a memory;
a datastore, wherein the datastore comprises one or more blocker status records, wherein each blocker status record comprises a content blocker state, and wherein each blocker status record corresponds to a unique ID of a browser;
a content obfuscator module, wherein the content obfuscator module is configured to:
update, in the datastore, the one or more blocker status records based on one or more received requests, wherein the updating comprises:
identifying, for each of the one or more received requests, a current unique ID;
determining, for each of the one or more requests, a current request type; and
setting, for each of the one or more requests, a current blocker state in a current blocker status record corresponding to the current unique ID based on the determined current request type and a previous blocker state of the current blocker status record; and
receive, by a fetch handling module, a first request for a first webpage from a browser operating on a client device;
retrieve, from a webserver, a first original webpage corresponding to the first request for the first webpage;
determine, based on the received first request, a first unique ID;
generate, in the datastore, a blocker status record for the first unique ID;
modify, by append a canary object, the first original webpage;
return, to the browser, the modified first original webpage;
receive, by the fetch handling module, a second request, wherein the second request is a request for a webpage;
retrieve, from the webserver, a second original webpage corresponding to the second request;
retrieve, from the datastore, a first content blocker state of the blocker status record corresponding to the first unique ID;
generate, based on the first content blocker state, a modified second original webpage, wherein the generating comprises performing one or more obfuscation processes; and
return, to the browser, the modified second original webpage.

9. The system of claim 8, wherein the one or more obfuscation processes comprise:
replacing one or more content elements with server side rendered elements; or
modifying the one or more content elements by encrypting the elements or a path of the element.

10. The system of claim 9, wherein the fetch handling module is further configured to classify each request from the browser into one or more types of requests.

11. The system of claim 10, wherein the one or more types of requests comprise:
a canary path request, wherein the canary path request corresponds to an appended canary object;
a static resource request; and
a content evasion instruction (CEI), wherein the CEI is encrypted.

12. The system of claim 11, wherein the classifying comprises an CEI instruction request determination, and wherein the CEI instruction request determination comprises:
checking if a request path is a valid hexadecimal string;
decoding an encrypted payload; and
matching the decoded payload with JSON representation of an CEI instruction set.

13. The system of claim 12, wherein the system further comprises a canary module configured to:
receive, from the fetch handling module, a first canary path request; and
update a blocker status record corresponding to a unique ID associated with the first canary path request based on a current content blocker state of the blocker status record.

14. The system of claim 13, wherein the unique ID of the browser is based on JA3 and/or JA4 fingerprinting of a TLS handshake.

15. A content obfuscation method, wherein the method is configured to:
detect, at an obfuscation server, a content blocker operating on a browser of a client device,
wherein the detection comprises:
receiving, from the browser, a first request for a webpage;
determining, based on the first request, a unique ID for the browser, wherein the unique ID of the browser is based on JA3 and/or JA4 fingerprinting of a TLS handshake;
generating, in the datastore, a blocker status record for the unique ID, wherein the blocker status record comprises a content blocker state;
retrieving, from a webserver, an original webpage corresponding to the first request;
generating a modified webpage by appending a canary path to the original webpage;
returning, to the browser, the modified webpage;
receiving, a next request from the browser;
determining, for the next request, a request type; and
determining, based on the request type, the content blocker state for the browser.

16. The method of claim 15, wherein the request type of the next request is a canary path request and the content blocker state is determined to be false based on the next request being a canary path request.

17. The method of claim 15, wherein the request type of the next request is not a canary path request and the content blocker state is determined to be true based on the next request not being a canary path request.

18. The method of claim 15, wherein the obfuscation server is further configured to:
receive, from the browser, a current request;
retrieve, from the datastore, a current blocker status record for the browser, wherein the retrieving comprises using the unique ID of the browser to query the datastore;
generating, based on the current request, a current request type and the blocker content state of the current blocker status record, an obfuscated webpage, wherein the generating comprises performing one or more obfuscation processes; and
return, to the browser, the obfuscated webpage.

19. The method of claim 18, wherein the one or more obfuscation processes comprise:
replacing one or more content elements with server side rendered elements; or
modifying the one or more content elements by encrypting the elements or a path of the element.

20. The method of claim 19, wherein determining the current request type further comprises a content evasion instruction (CEI) determination, and wherein the CEI determination comprises:
checking if a request path of the current request is a valid hexadecimal string;
decoding an encrypted payload; and
matching the decoded payload with JSON representation of a CEI instruction set.
